(19) United States
(12) Patent Application Publication
(10) Pub. No.: US 2018/0228321 A1
(43) Pub. Date: Aug. 16, 2018

(54) TISSUE BOX ATTACHMENT

(71) Applicant: George Khoury Kurker, East Falmouth, MA (US)

(72) Inventor: George Khoury Kurker, East Falmouth, MA (US)

(21) Appl. No.: 15/896,448

(22) Filed: Feb. 14, 2018

Related U.S. Application Data
(60) Provisional application No. 62/459,945, filed on Feb. 16, 2017.

(51) Int. Cl. A47K 10/18; B65D 83/08; B65F 1/14

(52) U.S. Cl. CPC A47K 10/185; B65D 2209/00; B65F 1/1426; B65D 83/0888

(57) ABSTRACT

A tissue box dispenser and waste receptacle. The tissue box dispenser and waste receptacle includes a tissue box attachment attached to a tissue box. The tissue box attachment includes a cuboid box having a top wall, a bottom wall, and a plurality of sidewalls. An opening is formed in at least one of the plurality of sidewalls leading into the cuboid box, forming a waste receptacle. A connector is configured to secure the top wall of the tissue box attachment to a bottom wall of the tissue box.

### CROSS-REFERENCE TO RELATED APPLICATION

This application claims the benefit of priority of U.S. provisional application No. 62/459,945, filed Feb. 16, 2017, the contents of which are herein incorporated by reference.

### BACKGROUND OF THE INVENTION

The present invention relates to tissues and, more particularly, to a tissue box attachment to add weight to a tissue box and to provide a receptacle for used tissues.

Facial tissue, paper handkerchief, and Kleenex refers to a class of soft, absorbent, disposable papers that are suitable for use on the face. They are disposable alternatives for cloth handkerchiefs. Paper tissue is usually sold in light weight cardboard boxes. Current tissue boxes do not include a waste receptacle for used tissues. Further, the diminished weight of the cardboard boxes due to the use of the tissues causes the box to raise and dangle when extracting a tissue.

As can be seen, there is a need for a tissue box attachment to add weight to a tissue box and to provide a receptacle for used tissues.

### SUMMARY OF THE INVENTION

In one aspect of the present invention, a tissue box attachment comprises: a cuboid box comprising a top wall, a bottom wall, and a plurality of sidewalls, and an opening formed in at least one of the plurality of sidewalls leading into the cuboid box; and a connector configured to secure the top wall of the cuboid box to a bottom wall of a tissue box.

In another aspect of the present invention, a method of adding a receptacle to a tissue box comprising the steps of: providing a tissue box attachment comprising a cuboid box comprising a top wall, a bottom wall, and a plurality of sidewalls, and an opening formed in at least one of the plurality of sidewalls leading into the cuboid box; and connecting the top wall of the tissue box attachment to a bottom wall of a tissue box.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a cross-sectional view of taken along line 2-2 of FIG. 1;

FIG. 3 is an exploded perspective view of an embodiment of the present invention; and

FIG. 4 is a cross-sectional view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

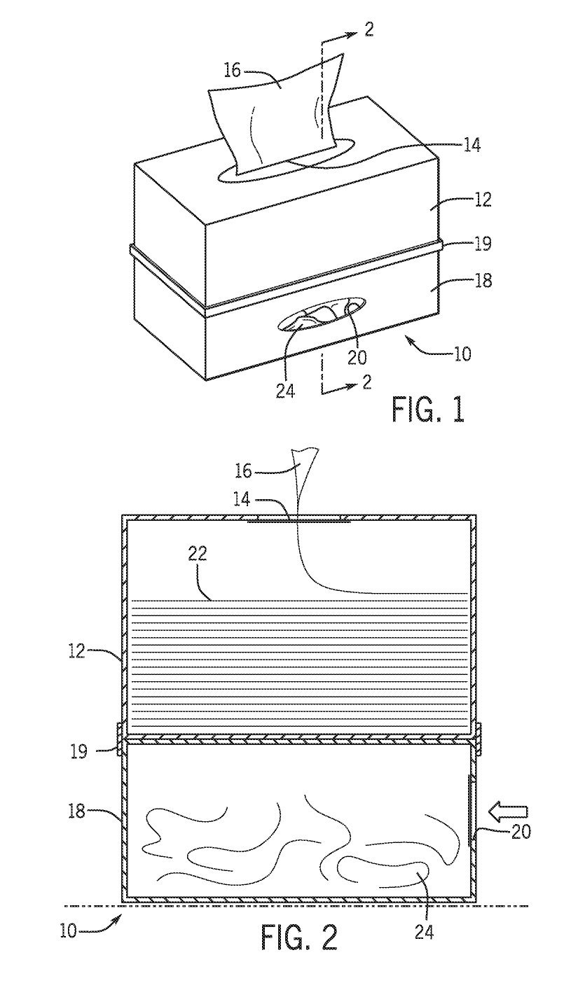

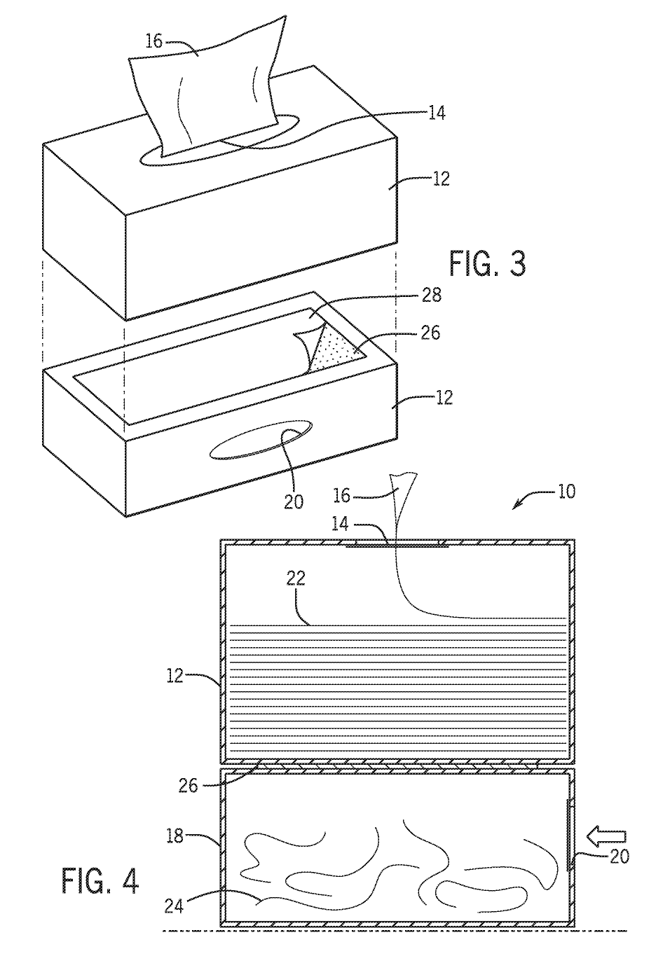

Referring to FIGS. 1 through 4, the present invention includes a tissue box dispenser and waste receptacle 10. The tissue box dispenser and waste receptacle 10 includes a tissue box attachment 18 attached to a tissue box 12. The tissue box attachment 18 includes a cuboid box having a top wall, a bottom wall, and a plurality of sidewalls. An opening 20 is formed in at least one of the plurality of sidewalls leading into the cuboid box, forming a waste receptacle. A connector 19, 26 is configured to secure the top wall of the tissue box attachment 18 to a bottom wall of the tissue box 12.

The tissue box 12 may be a standard tissue box made of a paper-based material. An upper wall of the tissue box 12 may include an opening 14. A plastic sheet may cover the opening and may include a slit. The plastic sheet may retain a portion of the tissue 16 outside of the tissue box 12. The tissue supply 22 may be stored within the tissue box 12.

The tissue box attachment 18 may be made of a paper-based material, such as cardboard. As mentioned above, the tissue box attachment 18 is a cuboid box. The cuboid box may include a width, a length and a height. The width and the length may be equal to the width and the length of the tissue box 12 that the tissue box attachment 18 is secured to. For example, if the tissue box 12 has a rectangular cuboid shape, the tissue box attachment 18 has a rectangular cuboid shape. Alternatively, if the tissue box 12 has a cubed shape, the tissue box attachment 18 has a cube shape.

The connector 19, 26 of the present invention may include an endless band 19, such as a slip-on band or an elastic band. In such embodiments, the endless band 19 wraps around a lower edge of the tissue box 12 and an upper edge of the tissue box attachment 18. The endless band 19 may be substantially thick enough to releasably secure the tissue box attachment 18 to the tissue box 12. In certain embodiments, the connector 19, 26 may be an adhesive layer 26 disposed on the top wall of the tissue box attachment 18. A peel-off cover 28 may be disposed over the adhesive layer 26. To use the invention, the user may remove the peel-off cover 28 and adhere the top wall of the tissue box attachment 18 to the bottom wall of the tissue box 12.

A method of adding a receptacle to a tissue box 12 includes the following steps. Provide the tissue box attachment 18 as described above and connect the top wall of the tissue box attachment 18 to the bottom wall of the tissue box 12. The step of connecting the top wall of the tissue box attachment 18 to the bottom wall of the tissue box 12 may include wrapping the endless band 19 around a lower edge of the tissue box 10 and wrapping the endless band 19 around an upper edge of the tissue box attachment 18. Alternatively, the step of connecting the top wall of the tissue box attachment 18 to the bottom wall of the tissue box 10 includes adhering the top wall of the tissue box attachment 18 to the bottom wall of the tissue box 10 by an adhesive 26. A user may then remove a tissue 16 from the tissue box 10, use the tissue 16 and dispose of the used tissue 24 through the opening 20 and into the tissue box attachment 18. The tissue box attachment 18 also adds weight to the tissue box 12, allowing for easier retrieval of the tissues 16 from the tissue box 12.

It should be understood, of course, that the foregoing relates to exemplary embodiments of the invention and that modifications may be made without departing from the spirit and scope of the invention as set forth in the following claims.

What is claimed is:

1. A tissue box attachment comprising:
a cuboid box comprising a top wall, a bottom wall, and a plurality of sidewalls, and an opening formed in at least one of the plurality of sidewalls leading into the cuboid box; and
a connector configured to secure the top wall of the cuboid box to a bottom wall of a tissue box.

2. The tissue box attachment of claim 1, wherein the cuboid box comprises a rectangular cuboid shape.

3. The tissue box attachment of claim 1, wherein the connector comprises an endless band configured to wrap around a lower edge of the tissue box and an upper edge of the tissue box attachment.

4. The tissue box attachment of claim 1, wherein the connector is an adhesive.

5. The tissue box attachment of claim 4, further comprising a peel-off cover disposed over the adhesive.

6. A method of adding a receptacle to a tissue box comprising the steps of:
providing a tissue box attachment comprising a cuboid box comprising a top wall, a bottom wall, and a plurality of sidewalls, and an opening formed in at least one of the plurality of sidewalls leading into the cuboid box; and
connecting the top wall of the tissue box attachment to a bottom wall of a tissue box.

7. The method of claim 6, wherein the cuboid box comprises a rectangular cuboid shape.

8. The method of claim 6, wherein the step of connecting the top wall of the tissue box attachment to the bottom wall of the tissue box comprises wrapping an endless band around an lower edge of the tissue box and wrapping the endless band around an upper edge of the tissue box attachment.

9. The method of claim 6, wherein the step of connecting the top wall of the tissue box attachment to the bottom wall of the tissue box comprises adhering the top wall of the tissue box attachment to the bottom wall of the tissue box by an adhesive.

10. The method of claim 9, further comprising the step of removing a peel-off cover disposed over the adhesive.
